(19) United States
(12) Patent Application Publication
(10) Pub. No.: US 2024/0132359 A1
(43) Pub. Date: Apr. 25, 2024

(54) GRAPHENE OXIDE HAVING ANTIMICROBIAL PROPERTIES, PREPARATION PROCESS AND USE THEREOF TO CONFER ANTIMICROBIAL PROPERTIES TO RUBBER ARTICLES

(71) Applicant: ENI S.P.A., Roma (IT)

(72) Inventors: Giulio ASSANELLI, San Donato Milanese (MI) (IT); Marcello NOTARI, San Donato Milanese (MI) (IT); Luca SERBOLISCA, San Donato Milanese (MI) (IT); Maurizio Stefano GALIMBERTI, Milano (IT); Gabriele CANDIANI, Milano (IT)

(21) Appl. No.: 18/546,179

(22) PCT Filed: Feb. 23, 2022
(86) PCT No.: PCT/IB2022/051572

§ 371 Date: Aug. 11, 2023

(30) Foreign Application Priority Data
Feb. 25, 2021 (IT) 102021000004463

(51) Int. Cl. C01B 32/198; C08J 5/02; C08K 3/04; C08K 5/19; C08L 7/02

(52) U.S. Cl. CPC C01B 32/198; C08J 5/02; C08K 3/042; C08K 5/19; C08L 7/02; C01P 2006/12; C08J 2307/02

(57) ABSTRACT

A process for preparing graphene oxide includes the steps of subjecting an aqueous dispersion of a graphite to an exfoliation step by high shear mixing at a mixing speed equal to or greater than 3000 rpm and to an oxidation step with an oxidizing agent selected from hydrogen peroxide, potassium hydroxide and mixtures thereof, wherein the graphite exfoliation step can precede, follow or be conducted together with the oxidation step. Also related is the use of the graphene oxide thus obtained to impart antimicrobial properties to rubber articles.

### CROSS-REFERENCE TO RELATED APPLICATIONS

This application is a 35 U.S.C. § 371 National Stage patent application of PCT/IB2022/051572 filed 23 Feb. 2022, which claims the benefit of Italian patent application 102021000004463 filed 25 Feb. 2021, the disclosures of which are incorporated herein by reference in their entirety.

### TECHNICAL FIELD

The present disclosure relates to a graphene oxide having antimicrobial properties, the preparation process and the use thereof to confer antimicrobial properties to rubber articles.

### BACKGROUND

It is well known that in many areas of technology, there is a need for rubber articles with antimicrobial properties, particularly antibacterial properties, whose action is prolonged over time. Such articles, for example, include medical devices, such as gloves, catheters, surgical drainage tubes, and everyday articles, such as bath caps, mattresses and toys. One solution to this technical problem is the production of rubber articles containing an antimicrobial agent dispersed in the rubber matrix, which releases the antimicrobial agent over an extended period of time.

In the state of the art, it is known that graphene-based materials, particularly in the oxidized form (graphene oxide) are able to exert an effective antimicrobial action on a wide range of microorganisms, including bacteria and fungi.

Examples of antimicrobial rubber articles (e.g. surgical gloves) incorporating graphene oxide as an antimicrobial agent are described in CN108948386A, CN107022124A.

Graphene is a two-dimensional nanomaterial consisting of a single layer of sp²-hybridised carbon atoms arranged in a hexagonal cell structure (also known as “honeycomb”).

Graphene oxide can be prepared starting from graphite using the Hummers I method (W. S. Hummers, R. E. Offeman, J. Am. Chem. Soc. 1958, 80, 1339). According to this method, graphite is exposed to strongly oxidizing conditions in a liquid phase formed by a mixture of sulphuric acid, potassium permanganate and sodium nitrate, resulting in the formation of graphene oxide. Several variants of the Hummers method are also known in which less hazardous reagents are used than those of the original method and which do not release toxic compounds.

The product obtained with the Hummers method is graphene oxide in the form of nanoplates containing a variable number of stacked graphene oxide layers. In general, the graphene oxide thus obtained is functionalised with oxygenated groups, such as hydroxyl, carbonyl and epoxy groups, which make it hydrophilic and favour the formation of stable aqueous dispersions.

The known state-of-the-art preparation methods based on the Hummers method and its modifications have the disadvantage of being rather complex, dangerous to implement due to the very severe reaction conditions and the type of reagents required, which are expensive and have a high environmental impact. In addition, graphene oxide obtained by these methods has highly variable antimicrobial properties that are strongly dependent on the synthesis conditions adopted. However, since it is not clear how the antimicrobial properties of graphene oxide depend on the synthesis variables, it is very difficult to optimise these processes to reproducibly prepare graphene oxide with the desired antimicrobial properties.

The Applicant further observed that commercially available graphene oxide produced by Hummers-type methods, when incorporated into rubber articles, has limited antimicrobial efficacy and its action is depleted in rather short times, presumably because manganese impurities deriving from the synthesis process hinder the formation of the oxidized species responsible for the antimicrobial effect.

It has also been observed that other antimicrobial agents commonly used to impart antimicrobial properties to rubber, such as quaternary ammonium salts (e.g. benzalkonium chloride) also exhibit an excessively rapid depletion of the antimicrobial action.

The disadvantages and drawbacks of graphene oxide and preparation techniques thereof known in the art represent a major limitation to the large-scale dissemination of antimicrobial rubber articles incorporating graphene oxide as an antimicrobial agent.

### SUMMARY

In consideration of the aforementioned state of the art, the need is therefore felt to have available methods for preparing graphene oxide that allow to obtain in a simple, economical and reproducible way, a product with an effective antimicrobial action, particularly when used in the production of antimicrobial rubber articles. It is also desirable that the antimicrobial action of such rubber articles is guaranteed over an extended period of time.

The Applicant has now found that this and other advantages, which will be further explained below, can be achieved by providing a preparation process including subjecting an aqueous dispersion of a graphite to at least one graphite exfoliation step by high shear mixing and one oxidation step thereof with hydrogen peroxide (H₂O₂) and/or potassium hydroxide (KOH), wherein the mixing is carried out at a mixing speed equal to or greater than 3000 rpm; the graphite exfoliation step to obtain graphene can precede, follow or be conducted together with the oxidation step to obtain graphene in the oxidized form. For the purposes of the present disclosure, the oxidation step introduces on the substrate being oxidized (i.e. graphene or graphite), oxygenated groups, such as hydroxyl, carbonyl and epoxy groups.

In one embodiment, the graphite is subjected to an oxidation step by means of an aqueous solution comprising at least hydrogen peroxide (H₂O₂) and/or potassium hydroxide (KOH) to obtain an oxidized graphite and, subsequently, an aqueous dispersion of the oxidized graphite is subjected to exfoliation by high shear mixing.

In another embodiment, an aqueous dispersion of graphite is subjected to exfoliation by high shear mixing to obtain graphene and, subsequently, an aqueous dispersion of the thus obtained graphene is subjected to an oxidation step by means of an aqueous solution comprising at least hydrogen peroxide (H₂O₂) and/or potassium hydroxide (KOH) to obtain graphene oxide.

In a preferred embodiment, the graphite oxidation and exfoliation steps are carried out simultaneously, i.e. by subjecting the dispersion of the graphite in the aqueous solution of hydrogen peroxide and/or potassium hydroxide to high shear stress mixing.

It has been observed that the above-mentioned exfoliation-oxidation process, in addition to being easy to carry out and economical, makes it possible to obtain graphene oxide with antimicrobial properties, in particular antibacterial one, with a high degree of reproducibility.

Furthermore, the graphene oxide thus obtained has a higher antimicrobial action than commercial products obtained with the Hummers method, even when incorporated into a rubber article.

Moreover, the graphene oxide obtainable by the process of the disclosure described here contains no potassium permanganate impurities that may affect the subsequent uses.

In addition, such obtained graphene oxide is characterized by the presence of oxidized groups only located on exposed sites (mainly in lateral edges) of the graphitic layers (EOGO).

Furthermore, the graphene oxide obtained with the process described here forms stable aqueous dispersions, even in the absence of stabilizing compounds (e.g. surfactants), and is easily mixable with both natural and synthetic rubber latex. It is therefore advantageously usable in the production of antimicrobial rubber articles starting from rubber latex.

It has also been observed that graphene oxide can be advantageously incorporated into a rubber latex along with other conventional antimicrobial substances, forming with them stable adducts that prolong the antimicrobial action of the rubber article.

In accordance with a first aspect, therefore, the present disclosure relates to a process for preparing a graphene oxide according to claim 1.

In accordance with a second aspect, the present disclosure relates to a graphene oxide obtainable by the aforesaid process in accordance with claim 10.

In accordance with a third aspect, the present disclosure relates to a rubber latex composition according to claim 11, comprising the aforementioned graphene oxide.

In accordance with a fourth aspect, the present disclosure relates to an antimicrobial rubber article according to claim 15, comprising the aforementioned graphene oxide.

In accordance with a fifth aspect, the present disclosure relates to the use of the aforementioned graphene oxide to impart antimicrobial properties to a rubber according to claim 17.

In accordance with a sixth aspect, the present disclosure relates to a process for producing an antimicrobial rubber article according to claim 18.

Further features of the above aspects of the present disclosure are defined in the dependent claims.

The characteristics and advantages of the method according to the present disclosure will become more evident from the following description. The description and the following examples of embodiment are provided for the sole purpose of illustrating the present disclosure and are not to be understood in a sense limiting the scope of protection defined by the appended claims.

The limits and the numerical intervals expressed in the present description and in the claims also include the mentioned numerical value or numerical values. Moreover, all the values or sub-intervals of a limit or numerical interval shall be understood to be specifically included as if they were explicitly mentioned.

The compositions according to the present disclosure may “comprise”, “consist of” or “consist essentially of the” essential and optional components described in the present description and in the appended claims.

For the purposes of the present description and the appended claims, the term “consist essentially of” means that the composition or the component may include additional ingredients, but only to the extent that the additional ingredients do not materially alter the essential characteristics of the composition or component.

For the purposes of this description and of the appended claims, the terms graphene and graphene oxide are to be understood according to the definitions given in ISO/TS 80004-13:2017 (Nanotechnologies—Vocabulary—Part 13: Graphene and related two-dimensional (2D) materials).

For the purposes of this description and of the appended claims, the term “antimicrobial” refers to a substance capable of killing micro-organisms or inhibiting their proliferation, thus having a bactericidal and/or bacteriostatic capacity.

### DETAILED DESCRIPTION OF THE DISCLOSURE

In accordance with the present disclosure, the process for preparing graphene oxide (GO) starting from graphite comprises an oxidation step of the graphite by contacting it with an aqueous solution comprising at least one oxidizing agent (oxidizing solution) selected from hydrogen peroxide (H₂O₂), potassium hydroxide and mixtures thereof.

In a particularly preferred embodiment, the exfoliation by high shear mixing is conducted directly on the dispersion of the starting graphite in hydrogen peroxide and/or potassium hydroxide. The graphene oxide thus obtained, in fact, was found to have a higher antimicrobial action.

The starting graphite is preferably graphite with a high surface area (HSAG) and provided with a high crystalline order within the structural layers. Preferably, graphite has a surface area in the range from 330 to 500 m²/g, as determined by the ASTM D 6556 method.

Preferably, graphite has a turbostratic structure with a relatively low number of stacked layers, e.g. 30 to 40 (approximately 35). Preferably, the lateral dimensions of the graphitic layers are about 300 to 400 nm, which can be estimated, for example, by high-resolution electron microscopy analysis.

Graphite preferably has a carbon content equal to or greater than 99% by weight. For example, the chemical composition of graphite, determined by elemental analysis, may be as follows: carbon (99.5% weight/weight), hydrogen (0.4% weight/weight), nitrogen 0.1% (weight/weight).

In a preferred embodiment, the oxidizing agent is hydrogen peroxide (H₂O₂). Preferably, an aqueous solution containing H₂O₂ is used at a concentration expressed as percentage by weight of H₂O₂ with respect to the weight of the solution in the range from 10% to 50%, preferably from 20% to 40%, even more preferably from 25% to 35%. Optionally, the oxidizing solution may also contain acetic acid.

The acetic acid may be advantageous as additive in combination with H₂O₂ since the acetic acid in combination with H₂O₂ can form peracetic acid, which is extremely active both as an oxidizing agent and as an anti-bacterial agent.

In a preferred embodiment, the oxidizing agent is potassium hydroxide (KOH). Preferably, an aqueous solution containing KOH is used at a concentration expressed as percentage by weight of KOH with respect to the weight of the solution in the range from 1% to 25%, preferably from 5% to 20%.

In one embodiment, the oxidizing agent consists of either H₂O₂ or KOH.

The concentration of graphite in the oxidizing solution is preferably in the range from 0.1% to 20%, more preferably in the range from 0.5% to 5%, even more preferably in the range from 0.8% to 2%, the aforesaid percentages being percentages by weight referred to the weight of the dispersion.

Preferably, the oxidation step, when not carried out under high shear mixing conditions, is carried out by keeping the graphite dispersed in the oxidizing solution by conventional mechanical stirring, for example by means of a magnetic stirrer.

Preferably, the oxidation step is carried out at a temperature in the range from 25° C. to 90° C., more preferably in the range from 35° C. to 50° C., even more preferably in the range from 55° C. to 80° C.

Preferably, the oxidation step is carried out at an absolute pressure in the range from 0.5 bar to 2 bar, more preferably in the range from 0.8 bar to 1.2 bar, even more preferably at atmospheric pressure.

The duration of the oxidation step, when not carried out under high shear mixing conditions, is preferably in the range from 5 to 24 hours, more preferably in the range from 7 to 10 hours, even more preferably in the range from 8 to 9 hours.

At the end of the oxidation step, the oxidized graphite can be separated from the oxidizing solution, filtered and dried to obtain a powdered product to be sent to the subsequent exfoliation step. To this end, powdered oxidized graphite is dispersed again in water and subjected to exfoliation by high shear mixing to obtain oxidized graphene oxide.

High shear mixing refers to mixing the graphite dispersion at a mixing speed equal to or greater than 3,000 rpm, preferably equal to or greater than 4,000 rpm, more preferably equal to or greater than 5,000 rpm.

Preferably, the mixing speed is equal to or less than 10,000 rpm, preferably equal to or less than 9,000 rpm, plus preferably equal to or less than 8,000 rpm.

In one embodiment, the mixing speed is in the range 4,000 rpm-9,000 rpm, more preferably in the range 5,000 rpm-7,000 rpm.

High shear mixing can be achieved with commercially available conventional devices such as rotor-stator mixers. These mixers comprise a mixing element (rotor) at high speed (typically 10 to 50 m-s−1) and a fixed element (stator) which are positioned in close proximity to each other so that the gap between the end of the rotor and the walls of the stator is very narrow, typically from 100 micrometres to 3 millimetres.

The duration of the high shear mixing step, when performed on an oxidized graphite dispersion prepared in a previous oxidation step, is preferably in the range from 5 minutes to 2 hours, more preferably in the range from 10 minutes to 1 hour.

In a particularly preferred embodiment, exfoliation by high shear mixing is conducted on the dispersion of the starting graphite in hydrogen peroxide. This variant of the process makes it possible to obtain the final graphene oxide directly, avoiding the formation of the intermediate graphite oxide, its separation from the oxidizing solution and its subsequent redispersion in water for the exfoliation step, with obvious advantages in terms of simplification of the process and reduction of the relative costs.

At the end of the exfoliation step, the solid graphene can be separated from the dispersion, filtered and dried to obtain the powdered product.

When the process involves first the exfoliation step of the starting graphite and then the oxidation step, each of the aforementioned steps can be carried out under the conditions described above for the variant of the process in which the oxidation precedes the exfoliation step.

The amount of oxygen-containing functional groups introduced on the graphene structure can be determined by Boehm titration, which is capable of quantifying the acid functional groups. Preferably, the amount of acid functional groups present on the graphene oxide in the range 1-20 mmol.

To this end, 100 mg of the sample to be analysed are dispersed in 50 mL of a 0.0492 M NaOH aqueous solution and kept under stirring at room temperature (25° C.) for 24 hours. The dispersion is then filtered. 10 mL of filtrate is mixed with 20 mL of 0.05 M HCl. The mixture, after adding phenolphthalein as a pH indicator, is titrated with a 0.0492 M NaOH aqueous solution.

The process according to the present disclosure, in addition to producing graphene oxide, may lead to the formation of varying amounts of other graphene materials in oxidized form, i.e., graphene materials having two or more superimposed layers of graphene, such as bilayer graphene, “few-layer graphene” composed of three to ten layers of graphene, and graphene nanoplates composed of superimposed graphene layers and having a thickness in the range from 1 nm to 3 nm and dimensions.

The process for preparing graphene oxide according to the present disclosure can be carried out with conventional devices and equipment known to the person skilled in the art.

The graphene oxide obtained by the process according to the present disclosure can be advantageously used to realize antimicrobial rubber articles.

Preferably, the graphene oxide is added to the rubber latex to form a latex composition with which to produce the antimicrobial rubber article.

For this purpose, graphene oxide can be added to rubber latex in the form of an aqueous dispersion. It has been observed that, advantageously, the graphene oxide produced by the process according to the present disclosure forms stable dispersions with water, even in the absence of dispersing compounds, such as surfactants, which can be mixed with rubber latex without causing coagulation.

Preferably, the aqueous dispersion comprises water and graphene oxide in a percentage by weight referred to the weight of the dispersion in the range from 0.1% to 1%, more preferably in the range from 0.2% to 0.7%.

Preferably, the graphene oxide is present in the rubber latex composition in an amount in the range from 1% to 15%, more preferably in the range from 5% to 10%, said percentages being percentages by weight referred to the total weight of the composition.

In a preferred embodiment, the rubber latex composition comprises, in addition to graphene oxide, at least one substance with an antimicrobial action other than graphene oxide.

The antimicrobial substance can be selected for example from: quaternary ammonium salt; polyglycol with molecular weight in the range from 200-12,000 g/mol; polysaccharide having antimicrobial properties, preferably chitosan, galactan, mannan and laminarine; metal ion having antimicrobial properties, preferably silver ions, sodium ions and zinc ions; chlorinated isothiazole; and mixtures thereof.

In one embodiment of the disclosure, the antimicrobial substance are selected from: quaternary ammonium salt; polyglycol with molecular weight in the range from 200-12,000 g/mol; polysaccharide having antimicrobial properties, preferably chitosan, galactan, mannan and laminarine; metal ion having antimicrobial properties selected from silver ions and sodium ions; chlorinated isothiazole; and mixtures thereof.

More preferably, the at least one antimicrobial substance is benzalkonium chloride.

The quaternary ammonium salts can be selected from quaternary ammonium salts containing benzyl groups and having hydrocarbon chains of various lengths (e.g. benzalkonium chloride, benzethonium chloride, benzalkonium bromide). Preferably, the quaternary ammonium salts have the following general formula I

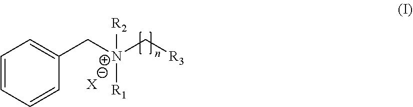

wherein:
R₁ and R₂ are independently an alkyl group containing a number of carbon atoms comprised between 1 and 10, preferably between 1 and 5 and even more preferably between 1 and 2;
R₃ is an alkyl group containing a number of carbon atoms comprised between 1 and 10, preferably between 1 and 5 and even more preferably between 1 and 2;
n is an integer between 1 and 20, preferably between 6 and 15 even more preferably between 8 and 12;
X represents a halogen counterion selected from fluorine, chlorine, bromine, iodine, preferably chlorine and bromine, even more preferably chlorine.

In one embodiment, quaternary ammonium salts have a polymeric structure. An example of such polymeric salts are polydiallyldimethylammonium halide compounds having the following general formula II

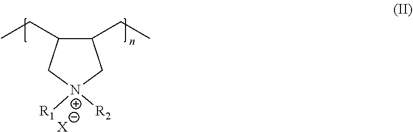

wherein:
R₁ and R₂ are an alkyl group containing a number of carbon atoms comprised between 1 and 10, preferably between 1 and 5 and even more preferably between 1 and 2;
n is an integer comprised between 1,000 and 3,000, preferably between 1,200 and 2,200;
X represents a halogen counterion selected from fluorine, chlorine, bromine, iodine, preferably chlorine and bromine, even more preferably chlorine.

The molecular weight of the salts of formula II is preferably comprised between 20,000 g/mol and 1,000,000 g/mol preferably between 80,000 and 600,000 g/mol more preferably between 200,000 and 350,000 g/mol.

In general, the antimicrobial substance other than graphene oxide is present in the latex composition in an overall amount in the range from 0.5% to 5%, more preferably in the range from 1% to 3%, the above percentages being percentages by weight referred to the total weight of the composition. Preferably, the weight ratio of the antimicrobial substance to the graphene oxide is in the range from 0.05 to 1, more preferably 0.1 to 0.75, even more preferably 0.2 to 0.5.

The antimicrobial substance other than graphene oxide can be used pure or in the form of an aqueous solution, the latter preferably at a concentration, expressed as percentage by weight of the antimicrobial substance with respect to the weight of the solution, in the range from 20% to 90%, preferably in the range from 30% to 80%, even more preferably in the range from 40% to 60%.

In a preferred embodiment, graphene oxide and the antimicrobial substance are added to the latex composition in adduct form. For example, when the antimicrobial substance is an ammonium salt, a graphene oxide-quaternary ammonium cation adduct can be obtained by converting the graphene oxide into the corresponding alkaline form by contacting graphene oxide with an alkali metal hydroxide (e.g. NaOH) in aqueous solution and, subsequently, by replacing the alkaline ions present on the graphene oxide with the cations of the quaternary ammonium salt.

In one embodiment, the quaternary ammonium salt is selected from benzalkonium halide, polydiallyldimethylammonium halide and mixtures thereof.

The treatment of graphene oxide with the alkali metal hydroxide enables the hydrogen atoms of the oxygenated groups present on the graphene oxide to be substantially completely replaced. The conversion of graphene oxide into the alkaline form, before treatment with the ammonium salt is necessary to form a graphene oxide-ammonium cation adduct in which there is a chemical bond between the graphene oxide and the ammonium salt, more particularly an ionic bond.

The treatment of graphene oxide with the alkali metal hydroxide or with the quaternary ammonium salt can be carried out by maintaining the graphene oxide under stirring in water, preferably at room temperature, in the presence of the alkaline hydroxide or quaternary ammonium salt. The alkaline hydroxide and the quaternary ammonium salt are present in the aqueous solution, for example in a stoichiometric quantity, i.e. in an amount sufficient to substantially completely replace the hydrogen atoms and/or the alkali metal ions present on the graphene.

The product obtained at the end of each of the above ion exchange treatments may be separated from the aqueous phase, for example by filtration, and subsequently washed with water and dried to obtain the powdered product. The graphene oxide-quaternary ammonium cation adduct can be added to the rubber latex in the form of an aqueous dispersion, as shown above for graphene oxide.

In order to obtain rubber articles having antimicrobial properties effective over a prolonged period of time, the latex composition preferably comprises the adduct together with at least one antimicrobial substance other than graphene oxide among those described above (e.g., benzalkonium halide, polydiallyldimethylammonium halide). Preferably, the additional antimicrobial substance is the same as the antimicrobial substance which forms the adduct with the graphene oxide.

It has been observed that the graphene oxide produced in accordance with the present disclosure, particularly when used in adduct form, exerts a stabilising action towards the antimicrobial substance, slowing its release from the surface of the rubber article.

Rubber latex can be either rubber latex from natural sources, so-called natural rubber latex, or an aqueous polymer dispersion, so-called synthetic latex or synthetic pseudo-latex.

The natural or synthetic latex-forming polymer includes homopolymers and copolymers of vinyl monomers and diene monomers, such as ethylene, styrene, isobutylene, vinyl acetate, vinyl chloride, vinylidene chloride, acrylonitrile, butadiene, neoprene, isoprene, chloroprene, 1,3-pentadiene, 1,5-hexadiene, 1,6-heptadiene, mixtures thereof, and copolymers (e.g., acrylonitrile-butadiene and styrene-isobutylene copolymers).

In a preferred embodiment, latex is natural rubber latex comprising poly(1,4-cis-isoprene).

Graphene oxide and rubber latex can be combined together with any of the techniques known in the art for rubber processing. If desired, one or more conventional additives, such as pH modifiers, hardeners, cross-linkers, vulcanisers, coagulants, antioxidants, pigments, surfactants, etc., may be added to the latex.

Preferably, the pH of the latex composition is maintained in the range from 9 to 11 to prevent the coagulation thereof, for example by addition of NH₄OH or other basifying compound.

The rubber latex composition comprising graphene oxide can be transformed into a rubber article by conventional methods known to the person skilled in the art. Generally, the process for forming rubber articles comprises the steps of:
deposition of the latex composition on the surface of a template or mold (e.g. of metal or ceramic material) having a suitable shape for obtaining the final article; this step may be repeated one or more times to deposit a layer of the desired thickness on the mold;
curing of the deposited latex layer by evaporation of the water present therein;
removal of the article formed by the mold.

The deposition of the latex on the surface of the mold can be achieved through one of the several known techniques, including dipping, pouring, spraying, spin-coating and combinations thereof.

The evaporation of water from latex is preferably achieved by exposure of the latex to a temperature in the range from 10° C. to 60° C., more preferably in the range from 20° C. to 40° C.

### BRIEF DESCRIPTION OF THE DRAWINGS

In order to further understand the features of the present disclosure, the following embodiment examples are provided below, which are described with reference to the following figures:

FIG. 1: calibration straight line of the BAC concentration in aqueous solution obtained on the basis of the UV absorbance values at 262 nm;

FIG. 2: UV absorption spectra of aqueous solutions containing BAC obtained in the release test.

### EXAMPLES

### Materials

High surface area graphite (HSAG) is the Nano 27 product from Asbury Graphite Mills, Inc. (Asbury, NJ, USA). Graphite has the following characteristics:
surface area 250 m²/g,
chemical composition from elemental analysis (U.S. Standard Test Sieves): carbon 99.82%, ash 0.18%, humidity 0.97%;
number of stacked layers equal to approximately 50.

Hydrogen peroxide (H₂O₂), 30% aqueous solution (w/w) from Sigma-Aldrich.

Natural latex poly(1,4-cis-isoprene) (NR) from Centex FA, having the following characteristics:
content of solids equal to 60% w/w,
pH (at 20° C.)=9.72,
density approx. 0.95 g/cm³.

Benzalkonium chloride (hereinafter BAC) from Sigma Aldrich.

### Example 1

### Preparation of GO by Oxidation and Subsequent Exfoliation

### 1A—Exfoliation of Nanographite

HSAG graphite (50 g), hereinafter referred to as G, was mixed with deionized water to obtain a concentration of 80 g/L in a 2 L beaker.

The obtained suspension was treated in a Silverson mixer at 5700 rpm for 20 minutes. The resulting mixture was filtered in a Buchner filter and the solid was washed with water under vacuum. A mass of wet solid equal to 50 g was obtained.

### 1B—Preparation of Oxidized Graphene (GO)

25 g of the product according to Example 1A were poured into a 1 L flask with magnetic stirrer. 100 mL of 30% H₂O₂ aqueous solution was added to the flask by means of a dropping funnel. The mixture was kept under stirring overnight at room temperature. The mixture was then removed from the flask, was filtered on a Buchner filter and then washed with deionized water, using again a Buchner filter, until a neutral pH was reached. The solid obtained after filtration was left exposed to the air overnight resulting in a dry powder. The dry powder was dispersed in deionized water (24 grams in 1 litre of deionized water. The dispersion was mixed at high shear with the Silverson mixer at 5700 rpm for 20 minutes. The mixing was carried out at room temperature (approximately 25 degrees). An increase in dispersion temperature of up to 45° C. was observed during mixing.

The dispersion was vacuum filtered by means of a Buchner filter and the solid washed with deionized water until a neutral pH was reached. The solid was left exposed to the air overnight. 32.5 g of wet powder were obtained, hereinafter referred to as GO.

To establish the quantity of acidic oxygenated groups present on the GO, the product was subjected to Boehm titration, obtaining 5 mmol/g as a result.

### Example 2

### Preparation of GO by Simultaneous Oxidation and Exfoliation

Into a reactor with 500 ml volume it was loaded: Nano 27 graphite marketed by Asbury Carbons (HSAG) (4.7 g), demineralized water (306.2 g), hydrogen peroxide in aqueous solution at 30% weight/weight Sigma Aldrich (160.14 g). The Silverson mixer was immersed in the reactor and the dispersion was homogenised at 5000 rpm for 3 hours. An increase in the dispersion temperature of up to approximately 70° C. was observed during mixing.

After mixing, an aqueous dispersion of GO with a concentration of approximately 10 mg/mL was obtained.

### Example 3

### Preparation of the Adduct (GOBAC) Between Graphene Oxide (GO) and Benzalkonium Chloride (BAC)

### 3A—Preparation of GONa

One litre of 0.1275 N NaOH aqueous solution (4.93 g, 123.25 mmol) was prepared in a 2 L beaker with magnetic stirrer.

The GO powder (24.65 g) obtained in Example 1B was added slowly to the solution and kept under stirring for 5 hours. The quantity of soda used was calculated starting from the content of acidic oxygenated groups present in the GO measured by Boehm titration (5 mmol/g GO, i.e. 123.25 mmol in 24.65 g). The suspension was filtered on Buchner, under reduced pressure, and washed with deionized water until neutral. The wet solid was allowed to air dry overnight. 30 g dry powder (GONa) were obtained.

### 3B—Preparation of GOBAC

10 g (30 mmol) of BAC were diluted in 400 mL of deionized water in a 1 L beaker with magnetic stirrer.

GONa (30 g, 150 mmol_{Na}) obtained in Example 3A was poured into the solution containing BAC and kept under stirring at room temperature for 3.5 hours. The amount of BAC added to the GONa suspension was calculated to obtain the complete conversion of BAC (BAC/Na=1:5 mol/mol), thus choosing BAC as the limiting reagent. The mixture was then filtered on a Buchner filter under reduced pressure and washed with deionized water until a neutral pH was reached. The wet solid was left exposed to the air overnight. 36.4 g of dry powder were obtained.

The nitrogen content of the GO, GONa and GOBAC samples is shown in Table 1.

TABLE 1

N

| | % w/w | SD [%] |
|---|---|---|
| GO | 0.56 | ±0.02 |
| GONa | 0.41 | ±0.02 |
| GOBAC | 1.26 | ±0.10 |

On the basis of the elemental analysis, the nitrogen content deriving from the BAC present in the GOBAC adduct was estimated to be equal to 0.85% weight/weight: 1.26% (percentage of N in GOBAC)−0.41% (percentage of N in GONa). Taking into account the average molar mass of BAC (339 g/mol) and a molar ratio of 1:1 between N and BAC, the amount of BAC present in the adduct was estimated to be approximately 20% by weight with respect to the weight of the adduct.

### Example 4

### Preparation of a Rubber Containing GO as an Antimicrobial Agent (NR/GO)

An appropriate volume of an aqueous solution containing 10 mg/mL of GO prepared according to the present disclosure (the volume was determined on the basis of the sample intended to be realized from those shown in Table 2) was poured into a beaker to which deionized water (dH₂O) was added until a final volume of 50 mL was reached. The pH was measured and adjusted by addition of NH₄OH 30% volume/volume up to a value of approximately 10.

In a second beaker, 5 g NR latex (natural rubber 60% weight/weight, H₂O 40% weight/weight) was mixed with 5 mL of dH₂O. The mixture was kept under stirring for 5 minutes.

The aqueous solution containing the GO of the first beaker was then poured into the second beaker containing latex and the mixture thus obtained was stirred for 10 minutes to obtain a homogeneous NR/GO dispersion.

For each NR/GO dispersion, three aliquots of 2 ml each were poured into respective wells of a multiwell plate. The plate with the samples was subjected to heat treatment in a stove at 40° C. for 24 hours to evaporate the water and obtain the antimicrobial rubber sample.

In the above manner, NR/GO samples were prepared with the compositions given in Table 2.

### Example 5

### Preparation of a Rubber Containing GOBAC as an Antimicrobial Agent (NR/GOBAC)

NR/GOBAC samples were prepared as described in

Example 4, using instead of GO the GOBAC prepared according to Example 3, in the amounts indicated in Table 2.

### Example 6

### (Comparative)—Preparation of a Rubber Containing Commercial GO as an Antimicrobial Agent (NR/GO-comm)

NR/GO-comm samples were prepared as described in Example 4, using instead of GO according to the present disclosure a commercially available GO produced by the company Abalonyx AS, Norway, in the amounts indicated in

Table 2. According to the Abalonyx product data sheet, this GO was prepared using a Hummers method. The GO had the following composition (% w/w): carbon 63-66%, oxygen 31-33%, sulphur 1-2%, nitrogen 0.1-1.5%, chlorides <0.5%.

### Example 7

### (Comparative)—Preparation of a Rubber Containing BAC as an Antimicrobial Agent (NR/BAC)

NR/BAC samples were prepared as described in Example 4, using BAC in the amounts indicated in Table 2 instead of GO according to the present disclosure.

### Example 8

### Preparation of a Rubber Containing GO and BAC as Antimicrobial Agents (NR/GO+BAC)

NR/GO+BAC samples were prepared as described in Example 4, using GO as the antimicrobial agent in combination with BAC in the amounts indicated in Table 2.

### Example 9

### Preparation of a Rubber Containing GOBAC and BAC as Antimicrobial Agents (NR/GOBAC+BAC)

NR/GOBAC+BAC samples were prepared as described in Example 4, using GOBAC as the antimicrobial agent in combination with BAC in the amounts indicated in Table 2.

TABLE 2*

| | | | | | | | | NR/GO − | | | | |
|---|---|---|---|---|---|---|---|---|---|---|---|---|
| | NR/GO | | | | NR/GOBAC | | | comm | | NR/BAC | | |
| | Example no. | | | | Example no. | | | Ex. no. | | Example no. | | |
| | 4.1 | 4.2 | 4.3 | 4.4 | 5.1 | 5.2 | 5.3 | 6.1 | 6.2 | 7.1 | 7.2 | 7.3 |
| NR | 100 | 100 | 100 | 100 | 100 | 100 | 100 | 100 | 100 | 100 | 100 | 100 |
| GO ex. 1 | 5 | 10 | — | 10 | — | — | — | — | — | — | | — |
| GO ex. 2 | — | — | 5 | 10 | — | — | — | — | — | — | | — |
| GOBAC | — | — | — | — | 5 | 10 | 17 | — | — | — | 10 | — |
| GO − comm | — | — | — | — | — | — | — | 5 | 10 | — | | — |
| BAC | — | — | — | — | — | — | — | — | — | 2 | 2 | 5 |

| | | NR/ | NR/ | NR/ | NR/ | NR/ | NR/ | NR/ |
|---|---|---|---|---|---|---|---|---|
| | | GO + | GO + | GO + | GOBAC + | GOBAC + | GOBAC + | GOBAC + |
| | NR/BAC | BAC | BAC | BAC | BAC | BAC | BAC | BAC |
| | Example no. | Example no. | | | Example no. | | | |
| | 7.4 | 8.1 | 8.2 | 8.3 | 9.1 | 9.2 | 9.3 | 9.4 |
| NR | 100 | 100 | 100 | 100 | 100 | 100 | 100 | 100 |
| GO ex. 1 | — | 1 | 5 | — | — | — | — | — |
| GO ex. 2 | — | — | — | 5 | — | — | — | — |
| GOBAC | — | — | — | — | 5 | 10 | 10 | 10 |
| GO − comm | — | — | — | — | — | — | — | — |
| BAC | 10 | 0.2 | 1 | 1 | 2 | 1 | 2 | 8 |

*Note:
the concentrations of the rubber components are expressed in phr (referring to 100 parts of polymer dispersed in latex)

### Antimicrobial Test

The antimicrobial action of some rubber samples indicated in Table 2 was evaluated towards E. coli JM109. For reference,

the NR latex sample free of antimicrobial agents and the NR/BAC and NR/GOBAC samples containing the same amount of BAC were taken into consideration.

The tests, carried out at least in triplicate for each material, were performed in accordance with the international standard for the measurement of antibacterial activity on plastic surfaces and other non-porous materials ISO 22196:2011 (E).

Bacteria were kept in culture in 5 mL of LB broth (Luria-Bertani) at 37° C. while stirring at 135 rpm, until an OD (Optical Density) at λ=600 nm (OD₆₀₀ₙₘ)≈0.2 was reached, approximately corresponding to 10⁹ bacteria/mL. OD was measured using Nanodrop2000, Thermofisher.

The bacterial suspension was subsequently centrifuged and the precipitate was resuspended in MilliQ/LB 2% volume/volume. This suspension was then diluted to reach the desired microbial concentration, equal to 10⁶ bacteria/mL.

Aliquots of 20 μL were seeded on LB-agar Petri dishes to verify, through a direct plate count of the Colony Forming Units (CFU), that the actual microbial concentration was equal to the desired one.

The resulting bacterial suspension was used as a test inoculum.

The OD results showed a mean value of OD₆₀₀ₙₘ=0.152 while the control count of the CFU by direct counting on the test inoculum plate showed a microbial concentration of 0.72×10⁵ bacteria/mL.

The antimicrobial test was performed on the outer surface of the rubber samples of Table 2. 50 μ1 of the test inoculum were seeded on the surface of each sample. The surface was then covered with previously sterilised square slides (18×18 mm, 324 mm²) in such a way that the drops of test inoculum were spread until they reached the edges of the slides. The desired microbial concentration on the surfaces of the samples to be tested is approximately 1.5×10⁴ CFU/cm2.

The multiwell plates containing the seeded samples were incubated at 37° C. and 90% RH for 24 hours.

Bacteria were recovered from the surfaces of the tested samples by adding 1 mL (V1) of SCDLP broth (Soybean Casein Digest with Lecithin and Polyoxyethylene Sorbitan Monooleate).

150 μL (V2) of the mixture of SCDLP and bacteria removed from the surface (SCDLP/recovered bacteria mixture) were taken from each sample, poured into a 96-multiwell plate and serially diluted 1:10 seven times in LB broth to reach a maximum dilution factor (D) of 1:10⁷.

For each sample, 20 μL of the SCDLP/recovered bacteria mixture and its seven serial dilutions were seeded and spread on LB-agar Petri dishes. Subsequently, the plates were incubated upside down for 24 hours at 37° C.

At the end of the incubation period, the number of colonies grown on the plates was determined by eye count. The number of live bacteria recovered from the surfaces of each sample tested was obtained through Equation (1) from the standard ISO 22196:2011 (E):

N=(C×D×V₁V₂) [symbol] /A (1)
where N is the number of live bacteria per cm² recovered from the samples; C is the mean value of CFU counted for the replicate plates; D is the dilution factor for the evaluated plates; V₁ is the volume, in mL, of SCDLP used to wash the slides; V₂ is the volume, in mL, of the SCDLP/recovered bacteria mixture that was taken from the tested samples; A is the surface area, in cm², of the slides.

Tables 3-8 show the antimicrobial efficiency (E.A. [%]) for each sample tested, calculated using the following expression:

E.A.=(1—bacteria survived on the sample being tested/bacteria survived on NR latex-only control sample)×100.

In the tables, “SD” indicates the standard deviation calculated for each sample based on the result of each of its replicates.

TABLE 3

| | | Example | Example | Example | Example |
|---|---|---|---|---|---|
| NR/BAC | Latex NR | 7.1 | 7.2 | 7.3 | 7.4 |
| E.A. [%] | 0 | 99.998 | 100 | 100 | 100 |
| SD [%] | 0 | 0 | 0 | 0 | 0 |

TABLE 4

| | | Example | Example |
|---|---|---|---|
| NR/GO | Latex NR | 4.1 | 4.3 |
| E.A. [%] | 0 | 65,768 | 100 |
| SD [%] | 0 | 17.989 | 0 |

TABLE 5

| | | Example |
|---|---|---|
| NR/GO-comm | Latex NR | 6.1 |
| E.A. [%] | 0 | 54.947 |
| SD [%] | 0 | 19.981 |

TABLE 6

| | | Example | Example |
|---|---|---|---|
| NR/GOBAC | Latex NR | 9.1 | 9.2 |
| E.A. [%] | 0 | 99.799 | 99.985 |
| SD [%] | 0 | 0.055 | 0.004 |

TABLE 7

| | | Example | Example |
|---|---|---|---|
| NR/GO + BAC | Latex NR | 8.1 | 8.2 |
| E.A. [%] | 0 | 100 | 100 |
| SD [%] | 0 | 0 | 0 |

TABLE 8

| | | Example | Example | Example |
|---|---|---|---|---|
| NR/GOBAC + BAC | Latex NR | 9.2 | 9.3 | 9.4 |
| E.A. [%] | 0 | 100 | 100 | 100 |
| SD [%] | 0 | 0 | 0 | 0 |

The comparison of the antimicrobial efficacy results reported in Tables 4 and 5 shows that GO prepared in accordance with the process according to the present disclosure has a higher antimicrobial action than the commercial GO produced by the modified Hummers method. In particular, the GO according to the disclosure prepared by simultaneously carrying out oxidation and exfoliation of the starting graphite (sample 4.3) is more effective than the GO prepared by carrying out oxidation and exfoliation in two successive steps.

The rubbers incorporating GO in combination with BAC also exhibit high antimicrobial efficacy, both when GO and BAC are incorporated separately (samples 8.1 and 8.2) and when added in GOBAC adduct form (samples 9.2-9.4).

Trials of BAC Release from Rubber Articles

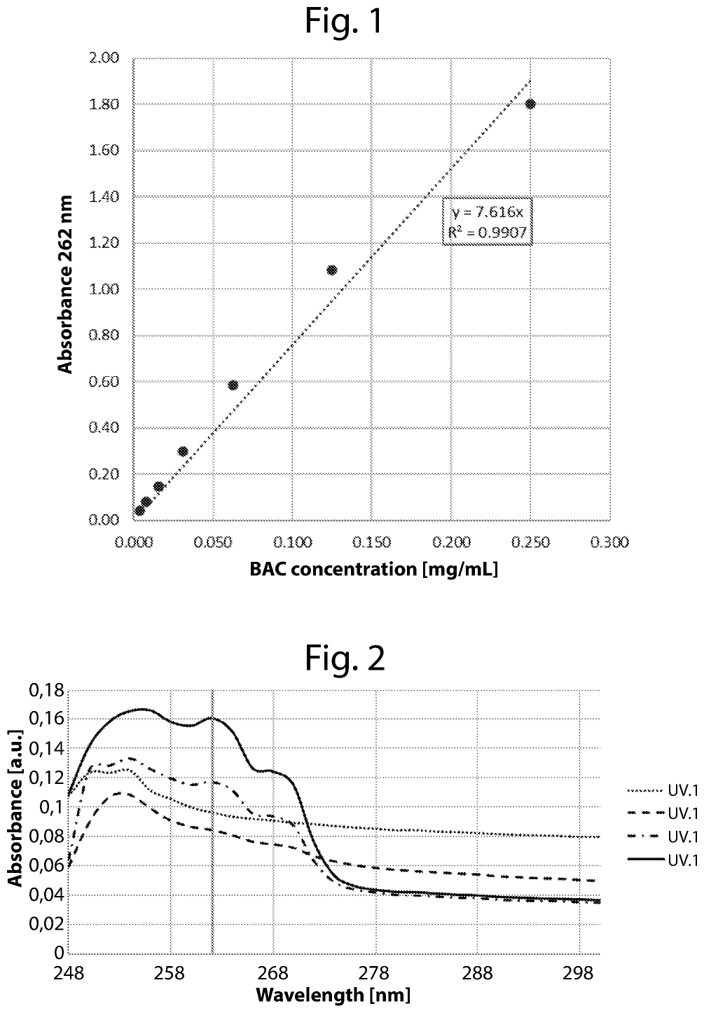

In order to evaluate the rate of release of the antimicrobial agent BAC from the rubber article incorporating it, a calibration straight line of different concentrations of BAC in water was first obtained. To this end, a series of BAC samples was prepared in deionized water at the following concentrations: 2 mg/mL, 1 mg/mL, 0.5 mg/mL, 0.25 mg/mL, 0.125 mg/mL, 0.063 mg/mL, 0.031 mg/mL, 0.016 mg/mL, 0.008 mg/mL and 0.004 mg/mL. Relative absorbance at 262 nm was measured on each sample by UV spectrophotometry. Based on the measured absorbances, the following calibration straight line was determined: Y=7.616×(R²=0.9907). The calibration straight line is represented graphically in FIG. 1.

The following process was performed for the release test. An amount of the test material and 30 mL of deionized water are added to a 50 mL tube to obtain a suspension at a concentration of 0.9 mg/mL. The suspension is kept under stirring at 135 rpm at a temperature of 25° C. for 24 hours by means of a swashplate stirrer provided with a thermostatically controlled chamber (Thermomixer MINI Desktop, Euroclone). Subsequently, the sample is centrifuged at 4500 rpm for 5 minutes by refrigerated centrifuge 3-16PK (Sigma Laborzentrifugen). At the end of the centrifugation, 25 mL of supernatant are taken, taking care not to remove the settled substance. The supernatant is then analysed by UV-Vis spectroscopy to determine the absorbance value at 262 nm. The absorbance value obtained is converted into the corresponding BAC concentration value by means of the calibration straight line of FIG. 1.

### Example UV.1

Trial of Extraction from GO Suspension

Following the process outlined above, 27 mg of the material in Example 1b (GO) and 30 mL of deionized water were added to a 50 mL tube to obtain a suspension at a concentration of 0.9 mg/mL.

### Example UV.2

Trial of Extraction from GOBAC Suspension

The same process as in Example UV.1 was performed, except that 30 mg of the material of Example 5 (GOBAC) and 30 mL of deionized water were added to a 50 mL tube in order to obtain a suspension at a concentration of 1 mg/mL. The composition of the GOBAC from elemental analysis appears to be: 90% GO (27 mg) and 10% BAC (3 mg).

### Example UV.3

Trial of Extraction from GO+BAC Suspension

The same process as reported in Example UV.1 was performed, except that 27 mg of the material of Example 2 (GO), 3 mg of BAC and 30 mL of deionized water were added to a 50 mL tube to obtain a suspension at a concentration of 0.9 mg/mL GO and 0.1 mg/mL BAC.

### Example UV.4

Trial of Extraction from GOBAC+BAC Suspension

The same process as reported in Example UV.1 was performed, except that 30 mg of the material of Example 5 (GOBAC), 3 mg of BAC and 30 mL of deionized water were added to a 50 mL tube to obtain a suspension at a concentration of 1 mg/mL GOBAC and 0.1 mg/mL BAC. The composition of the GOBAC from elemental analysis appears to be: 90% GO (27 mg) and 10% BAC (3 mg).

Table 9 shows the compositions of the samples analysed and the concentrations of BAC detected in the respective supernatants.

TABLE 9

| | Example | Example | Example | Example |
|---|---|---|---|---|
| | UV.1 | UV.2 | UV.3 | UV.4 |
| | GO | GOBAC | GO + BAC | GOBAC + BAC |
| Total concentration of GO | 0.9^{b} | 1.0 | 1.0 | 1.1 |
| and BAC [mg/mL] | | | | |
| GO [mg/mL] | 0.9 | 0.9 | 0.9 | 0.9 |
| BAC in bound form^{a} [mg] | 0.0 | 0.1 | 0.0 | 0.1 |
| BAC in free form^{a} [mg] | 0.0 | 0.0 | 0.1 | 0.1 |
| Absorbance at 262 nm | — | 0.08444 | 0.11725 | 0.16019 |
| [a.u.] | | | | |
| BAC in the supernatant | 0.0 | 0.010 | 0.013 | 0.018 |
| [mg/mL] | | | | |
| BAC released [%] | 0 | 10% | 13% | 9% |

^{a}Referred to 1 mL of solution
^{b}BAC: 0 mg

The results in Table 9 show that the adducts containing GO (i.e. GOBAC and GO+BAC) release a minority amount of BAC. This is particularly true in the case of

GOBAC, an adduct in which BAC is bound to GO by an ionic bond, which releases only 10% of BAC. This is also true in the case of GO+BAC and GOBAC+BAC, which release 13% and 9%, respectively. The moderate release of BAC indicates that, if these adducts are used in a rubber article, they can exert a prolonged antimicrobial effect. The particular stability of the adducts containing GOBAC is also evident.

1. A process for preparing graphene oxide, the process including the following steps:
subjecting an aqueous dispersion of a graphite to an exfoliation step by high shear mixing at a mixing speed equal to or greater than 3000 rpm and to an oxidation step with an oxidizing agent selected from hydrogen peroxide, optionally mixed with acetic acid, potassium hydroxide and mixtures thereof,
wherein the graphite exfoliation step can precede, follow or be conducted together with the oxidation step.

2. The process according to claim 1, further including the following steps:
a. subjecting an aqueous dispersion of a graphite to high shear mixing at a mixing speed equal to or greater than 3000 rpm, to obtain graphene, and
b. contacting said graphene with an aqueous solution comprising at least one oxidizing agent to obtain graphene oxide, the oxidizing agent being selected from hydrogen peroxide, optionally mixed with acetic acid, potassium hydroxide and mixtures thereof.

3. The process according to claim 1, further including the following steps:
a. contacting a graphite with an aqueous solution comprising at least one oxidizing agent to obtain an oxidized graphite, the oxidizing agent being selected from hydrogen peroxide, optionally mixed with acetic acid, potassium hydroxide and mixtures thereof, and
b. subjecting an aqueous dispersion of said oxidized graphite to high shear mixing at a mixing speed equal to or greater than 3000 rpm, to obtain said graphene oxide.

4. The process according to claim 3, wherein step b is carried out simultaneously with step a, by subjecting a dispersion of said graphite in said aqueous solution comprising said oxidizing agent to high shear mixing at a mixing speed equal to or greater than 3000 rpm.

5. The process according to claim 1, wherein said at least one oxidizing agent is hydrogen peroxide, optionally mixed with acetic acid.

6. The process according to claim 1, wherein said mixing speed is equal to or greater than 4000 rpm.

7. The process according to claim 1, wherein said graphite has a surface area in the range 330-500 m²/g, determined with the ASTM D6556 method.

8. The process according to claim 1, further including the following steps:
contacting said graphene oxide with an aqueous solution of alkaline ions to obtain graphene oxide in alkaline form, and
contacting said graphene oxide in alkaline form with an aqueous solution of a quaternary ammonium salt to obtain a graphene oxide-quaternary ammonium cation adduct.

9. The process according to claim 8, wherein said quaternary ammonium salt is selected from the group consisting of: benzalkonium halide, polydiallyldimethylammonium halide and mixtures thereof

10. Graphene oxide obtainable by the process according to claim 1.

11. A rubber latex composition comprising a rubber latex wherein an antimicrobial agent is dispersed, said antimicrobial agent comprising at least graphene oxide according to claim 10.

12. The composition according to claim 11, wherein said antimicrobial agent comprises at least one antimicrobial substance other than said graphene oxide.

13. A composition according to claim 12, wherein said antimicrobial substance is selected from the group consisting of: quaternary ammonium salt; polyglycol with molecular weight in the range from 200-12.000 g/mol; polysaccharide having antimicrobial properties; metal ion having antimicrobial properties; chlorinated isothiazole; and mixtures thereof.

14. The composition according to claim 12, wherein said at least one antimicrobial substance other than said graphene oxide is benzalkonium chloride.

15. Rubber antimicrobial article comprising an antimicrobial agent comprising a graphene oxide, said article being formed from a rubber latex composition according to claim 11.

16. Antimicrobial rubber article according to claim 15, selected from the group consisting of: glove, cot, catheter, surgical drainage tube, condom, contraceptive diaphragm, bath cap, and mattress.

17. Use of a graphene oxide according to claim 10 to impart antimicrobial properties to a rubber, optionally in combination with at least one antimicrobial substance other than said graphene oxide.

18. Process for producing an antimicrobial rubber article including the following steps:
i. mixing a rubber latex with an aqueous dispersion comprising a graphene oxide obtained according to claim 1 to obtain a latex composition,
ii. depositing the latex composition from step i on the surface of a mold,
iii. evaporating water from said latex composition, and
iv. removing the antimicrobial rubber article from the mold.
